(19) United States
(12) Patent Application Publication
(10) Pub. No.: US 2012/0147336 A1
(43) Pub. Date: Jun. 14, 2012

(54) PROJECTION-TYPE DISPLAY APPARATUS

(76) Inventor: Shinichiro Chikahisa, Tokyo (JP)

(21) Appl. No.: 13/390,921

(22) PCT Filed: Aug. 18, 2009
(86) PCT No.: PCT/JP2009/064421

§ 371 Date: Feb. 16, 2012

(51) Int. Cl. G03B 21/14

(52) U.S. Cl. 353/38

(57) ABSTRACT

A projection-type display apparatus is provided with a light source, an integrator (21), and a first light shielding plate (24) and a second light shielding plate (25). The integrator includes a lens array in which a plurality of lens elements are arranged in matrix form. The first light shielding plate and the second light shielding plate are constructed so as to be able to open and close in cooperation with each other in such a manner as to adjust a quantity of light. Cuts (24a and 25a) are respectively formed in end sides of the first light shielding plate and the second light shielding plate opposed to each other. The cuts in the first light shielding plate and the second light shielding plate are constructed so as to form, in a state of limiting the quantity of light to the minimum, a hexagonal window (41) through which light can pass. The hexagonal window includes a first region in rectangular form corresponding to at least four central lens elements close to each other in the plurality of lens elements comprising the lens array, and a second region in triangular form including two sides at angles from boundary lines between the plurality of lens elements.

### TECHNICAL FIELD

The present invention relates to a projection-type display apparatus comprising a mechanism for adjusting a quantity of light.

### BACKGROUND ART

A projection-type display apparatus causes light emitted from a light source to be projected as an image onto a screen. Projection-type display apparatuses of this kind include one comprising an integrator that uniformizes the distribution of the intensity of illumination light from a light source and a light control unit that adjusts the quantity of light.

The integrator is, for example, of a type in which two lens arrays are disposed in parallel with each other and each includes a plurality of lens elements arranged in matrix form. Light emitted from the light source is divided into a plurality of light beams by the lens arrays that form the integrator and that include a plurality of lens elements. The divided light beams are thereafter superposed on each other on a display element such as a liquid crystal panel so that the distribution of brightness (distribution of illumination intensity) is uniform.

The light control unit is, for example, of a type in which a pair of light shielding plates are provided between the lens arrays of the integrator. The light shielding plates are constructed so as to be movable closer to each other from opposite sides of an optical axis of the integrator and movable away from each other, and are capable of being opened and closed together. The quantity of light is adjusted through the distance between the light shielding plates. When the pair of light shielding plates are set closest to each other (closed position), the pair of light shielding plates are in a combined state such as to form an opening having a predetermined shape. In the closed position, the light shielding plates allow only light beams corresponding to the opening to pass therethrough while blocking the other light beams. With this arrangement, the intensity of light applied onto the display element can be adjusted, so that the apparent contrast of a projected image can be adjusted.

In adjusting the quantity of applied light by using the light shielding plates in this way, the shape of the opening between the light shielding plates is a factor that is taken into consideration. In a case where the shape of the opening is rectangular, there is a problem that noticeable illumination intensity nonuniformity occurs in the course of closing the light shielding plates. JP2007-286391A (hereinafter referred to as Patent Literature 1), JP2008-096629A (hereinafter referred to as Patent Literature 2) and JP2009-015295A (hereinafter referred to as Patent Literature 3) disclose techniques to reduce the non-uniformity of the illumination intensity, for example.

Patent Literature 1 describes that two rectangular openings are formed when light shielding plates are in the closed position. The two openings are formed at positions corresponding to an arc image. The openings are formed by avoiding the optical axis of the integrator.

In a technique described in Patent Literature 2, cuts are formed in end sides of a pair of light shielding plates opposed to each other. As the light shielding plates are brought closer to the closed position, two rhombus openings are formed by these cuts. These openings are formed by avoiding the optical axis of the integrator.

Patent Literature 3 describes that a technique using light shielding plates bent in the direction of reducing the quantity of light (shielding against light) so as to be “<”-shaped.

With each structure, however, there is a problem that non-uniformity of the illumination intensity in the course of opening or closing the light shielding plates will be seen.

### Citation List

### Patent Literature

Patent Literature 1: JP2007-286391A

Patent Literature 2: JP2008-096629A

Patent Literature 3: JP2009-015295A

### Summary of Invention

An object of the present invention is to provide a projection-type display apparatus that solves the above-described problem.

A projection-type display apparatus in one embodiment of the present is provided with a light source, an integrator, and a first light shielding plate and a second light shielding plate. The integrator uniformizes the distribution of intensity of illumination light from the light source, and includes a lens array in which a plurality of lens elements are arranged in matrix form. The first light shielding plate and the second light shielding plate adjust the quantity of light passing through the integrator. The first light shielding plate and the second light shielding plate are constructed so as to be able to open and close in cooperation with each other. Cuts symmetric with each other are respectively formed in end sides of the first light shielding plate and the second light shielding plate opposed to each other. The cuts in the first light shielding plate and the second light shielding plate are constructed so as to form, when the first light shielding plate and the second light shielding plate are in a state of limiting the quantity of light to the minimum, a hexagonal window through which light can pass. The hexagonal window includes a first region in rectangular form corresponding to at least four central lens elements close to each other in the lens array, and a second region in triangular form including two sides angled from boundary lines that are located between the lens elements.

The above-described and other objects, features and advantages of the present invention will become apparent from the following description with reference to the accompanying drawings illustrating the present invention.

### BRIEF DESCRIPTION OF DRAWINGS

FIG. 1 is an exploded perspective view of a projection-type display apparatus in an exemplary embodiment.

FIG. 2 is an exploded perspective view of a light control unit and an integrator that the projection-type display apparatus shown in FIG. 1 includes.

FIG. 3 is a perspective view of the light control unit shown in FIG. 3.

FIG. 4 is a schematic plan view showing a state where a first light shielding plate and a second light shielding plate, that the light control unit shown in FIG. 3 includes, are closed.

FIG. 5 is a schematic plan view of light-shielding plates in a comparative example, which is a Related Art of the present invention.

FIG. 6 is a schematic diagram for explaining measurement of illumination intensity.

FIG. 7 is a graph showing changes in the relative illumination intensity ratio accompanying opening/closing of the light shielding plates.

FIG. 8 is a graph showing changes in the in-plane illumination intensity ratio accompanying opening/closing of the light shielding plates.

FIG. 9 is a graph showing changes in light-controlled contrast accompanying opening/closing of the light shielding plates.

FIG. 10 is a schematic plan view of light shielding plates in another comparative example.

FIG. 11 is a schematic plan view of light shielding plates in still another comparative example.

FIG. 12 is a schematic plan view of a modified example of the first light shielding plate and the second light shielding plate.

### DESCRIPTION OF EMBODIMENT

An exemplary embodiment will be described with reference to the drawings. A projection-type display apparatus of the present invention is suitably used, for example, as a projector.

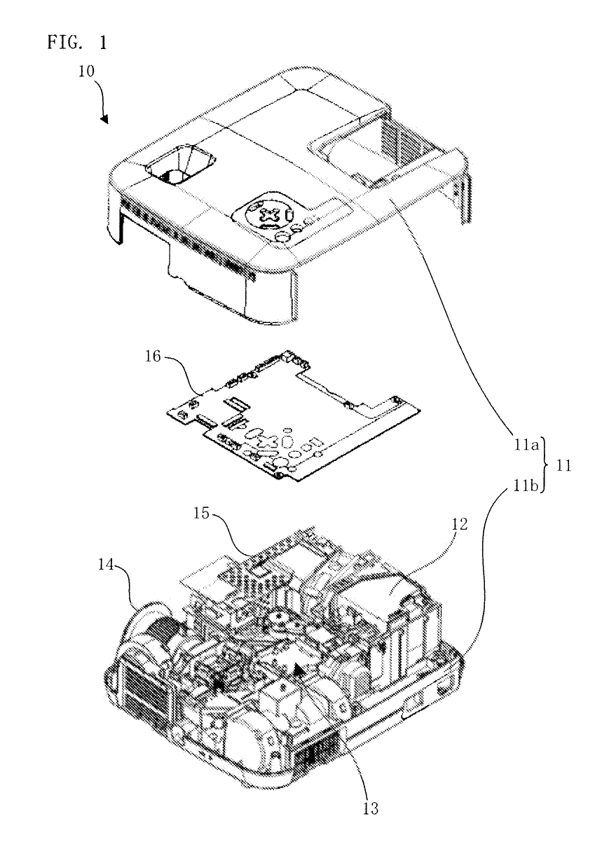

FIG. 1 is an exploded perspective view of a projection-type display apparatus in an exemplary embodiment. Projection-type display apparatus 10 includes first casing portion 11a and second casing portion 11b. First casing portion 11a and second casing portion 11b are combined to form casing 11.

Projection-type display apparatus 10 includes light source 12, optical engine 13, projection lens 14, power supply unit 15 and main circuit board 16. These components are disposed in casing 11. Light emitted from light source 12 is processed by optical engine 13 and is thereafter projected out of casing 11 by being passed through projection lens 14.

Electric wiring is formed on main circuit board 16 and electronic components for operating projection-type display apparatus 10 are mounted on main circuit board 16. Power supply unit 15 is provided for the purpose of supplying electric power, for example, to light source 12 and main circuit board 16.

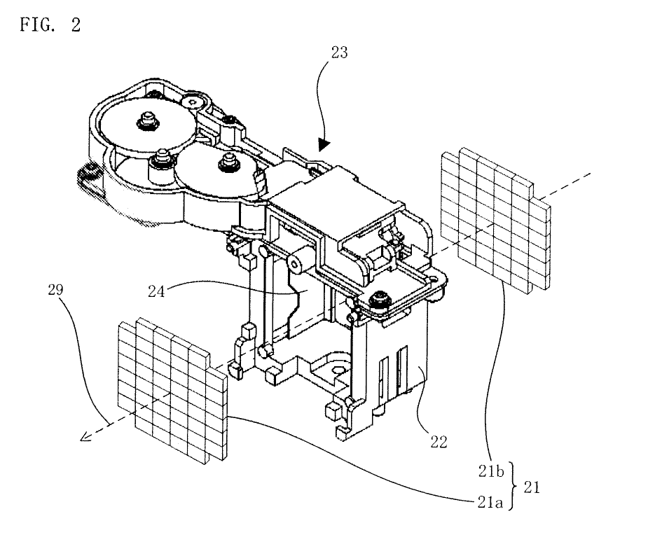

FIG. 2 is an exploded perspective view showing a portion of optical engine 13. Optical engine 13 includes integrator 21 that uniformizes a distribution of intensity of illumination light from light source 12, and light control unit 23 that adjusts the quantity of light. Projection lens 14 projects light passed through light control unit 23.

Integrator 21 is formed of first lens array (fly-eye lens) 21a and second lens array 21b in which a plurality of rectangular lens elements are arranged in matrix form. First lens array 21a and second lens array 21b are held on holder 22.

Light control unit 23 includes first light shielding plate 24 and second light shielding plate 25. First light shielding plate 24 and second light shielding plate 25 are set between first lens array 21a and second lens array 21b.

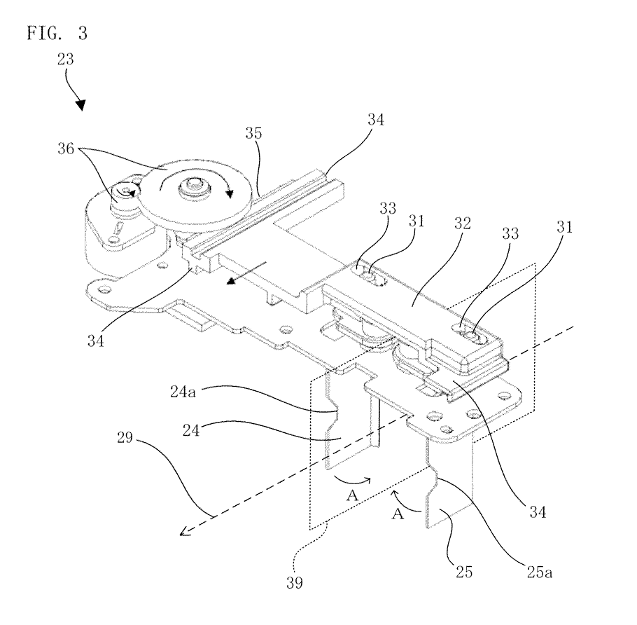

FIG. 3 is a schematic perspective view of light control unit 23. First light shielding plate 24 is disposed opposite from second light shielding plate 25 with respect to the reference plane 39 containing optical axis 29 of the integrator and parallel to one direction T (vertical direction in the case shown in FIG. 3) the of the arrangement of the plurality of lens elements arranged along vertical and lateral directions. First light shielding plate 24 and second light shielding plate 25 are constructed so as to be able to open and close in cooperation with each other. As light shielding plates 24 and 25 are closed, light beams traveling along optical axis 29 2D are blocked from opposite sides of optical axis 29 of the integrator.

An example of a mechanism that opens and closes first light shielding plate 24 and second light shielding plate 25 will be described in detail.

Light control unit 23 includes drive member 32 provided so as to be movable in translation motion and rotating gear train 36 for transmitting drive force to drive member 32. Rotating gear train 36 is driven by a drive controller (not shown) provided in casing 11.

The drive controller drives and rotates rotating gear train 36. Rotating gear train 36 meshes with rack gear 35 fixed on drive member 32. As a result, translation motion of rack gear 35 and drive member 32 is caused when rotating gear train 36 is rotated.

Drive member 32 includes pin guides 33 formed of holes in which drive pins 31 with which first light shielding plate 24 and second light shielding plate 25 are driven are inserted. By translational motion of drive member 32, drive pins 31 moves. Thus, first light shielding plate 24 and second light shielding plate 25 are made turnable in the directions of arrows A in FIG. 3 on turn axes parallel to one direction T of arrangement of the lens elements comprising the lens arrays.

With turning of first light shielding plate 24 and second light shielding plate 25, first light shielding plate 24 and second light shielding plate 25 open or close to adjust the quantity of light.

The mechanism for opening and closing the light shielding plates is not limited to that shown in FIG. 3.

First light shielding plate 24 and second light shielding plate 25 are continuously controllable between a fully open position and a fully closed position. Thus, the quantity of light is continuously adjusted. The control is not limited to this. First light shielding plate 24 and second light shielding plate 25 may be stepwise controllable between the fully open position and the fully closed position.

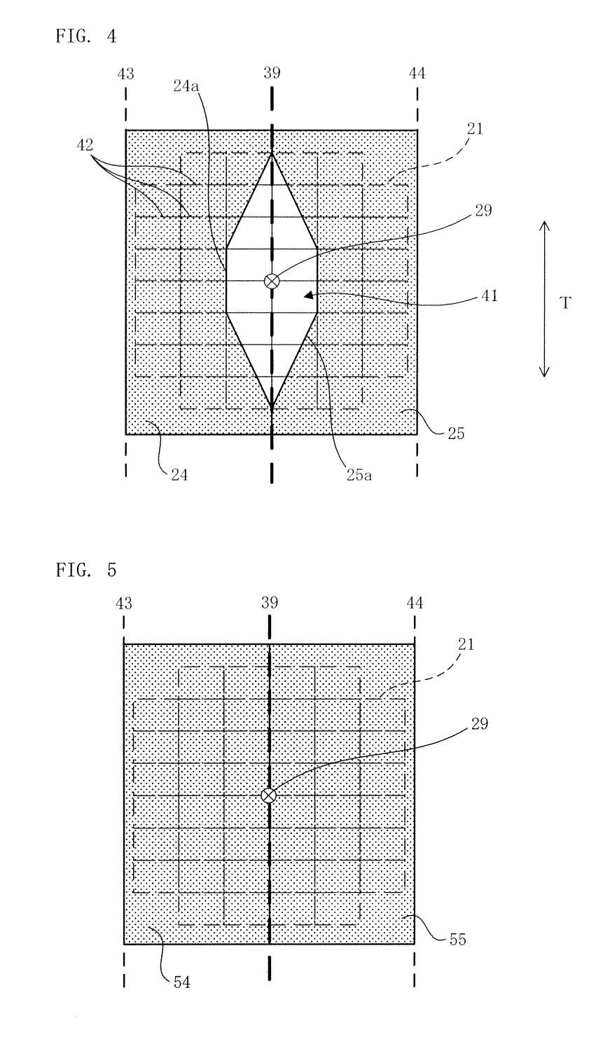

FIG. 4 is a view of integrator 21 and first and second light shielding plates 24 and 25 as viewed in a front-to-rear direction. First light shielding plate 24 and second light shielding plate 25 are set closest to each other in the fully closed position. First light shielding plate 24 and second light shielding plate 25 turn on turn axes 43 and 44 parallel to one direction T of arrangement of the lens elements.

First light shielding plate 24 and second light shielding plate 25 include cuts 24a and 25a respectively formed in their one-end sides (see FIG. 3 as well). More specifically, cuts 24a and 25a are formed in end sides of first and second light shielding plates 24 and 25 opposed to each other.

Cut 25a formed in second light shielding plate 25 has a shape such as to form symmetry about optical axis 29 with cut 24a in first light shielding plate 24. When first light shielding plate 24 and second light shielding plate 25 are in the fully closed position in which they limit the quantity of light to a minimum, cut 24a in first light shielding plate 24 and cut 25a in second light shielding plate 25 form hexagonal window 41 through which light can pass.

Hexagonal window 41 includes first region 41a in rectangular form corresponding to at least four central lens elements close to each other in the plurality of lens elements comprising each lens array, and second region 41b in triangular form that includes two sides angled from boundary lines 42 that are located between the plurality of lens elements.

That is, hexagonal window 41 includes two sides extending along boundary lines 42 between the plurality of lens elements parallel to each other and four sides at angles from boundary lines 41 between the plurality of lens elements.

It is preferable that six vertices of hexagonal window 41 substantially coincide with points at which the boundary lines that are located between the plurality of lens elements intersect each other, as seen in a direction along optical axis 29 of the integrator.

It is preferable that optical axis 29 of the integrator pass through a center of hexagonal window 41. It is also preferable that at least four central lens elements close to each other in lens arrays 21a and 21b be contained in hexagonal window 41.

In the present exemplary embodiment, the two sides forming triangular region 41b of the hexagonal window are straight lines set at angles from boundary lines 41 that are located between the plurality of lens elements. During transition from the open position to the closed position or from the closed position to the open position, therefore, the end sides of light shielding plates 24 and 25 do not uniformly block light between the plurality of lens elements comprising the lens arrays. When the light beams that pass through integrator 12 are superposed on each other on the display element, the light beams are superposed in different light-shielded states. As a result, the boundaries between light portions and dark portions are formed at various positions, thus reducing non-uniformity of the illumination intensity.

In some case where the cuts formed in the light shielding plates are rectangular, a plurality of the lens elements in a column in the lens array are simultaneously light-shielded in the course of opening or closing the light shielding plates. In such a case, the boundaries between light portions and dark portions are aligned, so that non-uniformity of the illumination intensity is noticeable. Further, in a case where the two sides forming triangular region 41b of the hexagonal window are curved lines, parts of the curved lines that are approximately parallel to the boundary lines between the lens elements and the plurality of the lens elements in a column in the lens array may be light-shielded substantially simultaneously. Therefore such a configuration is not preferable.

A reduction in contrast of a projected image is ascribable mainly to light largely angled from optical axis 29 of the integrator. In the present exemplary embodiment, the quantity of light with the large angle is small at the center of hexagonal window 41, i.e., in a vicinity of optical axis 29 of the integrator. Therefore, a high-contrast image can be maintained even if light passing in the vicinity of optical axis 29 of the integrator is not blocked.

FIG. 5 is a schematic plan view of light shielding plates 54 and 55 in a comparative example. Two light shielding plates 54 and 55 in the comparative example are rectangular. In the comparative example, when light shielding plates 54 and 55 are in the fully closed position, no window is formed to allow passage of light. The results of comparison between the illumination intensity obtained by using light shielding plates 54 and 55 in the comparative example and the illumination intensity obtained by using light shielding plates 24 and 25 in the present exemplary embodiment will be described below.

The relative illumination intensity ratio defined below is first evaluated. In this specification, the relative illumination intensity ratio is defined as a value (percentage) obtained by dividing an average illumination intensity when the light shielding plates are in a certain position by an average illumination intensity when the light shielding plates are in the fully open position. That is, the relative illumination intensity ratio is an index indicating the rate of reduction in illumination intensity under light control with the light shielding plates.

The average illumination intensity is measured based on the ANSI (American National Standards Institute) standard and is defined as an average value of illumination intensities measured at nine points on a projection plane to which light is projected. FIG. 6 shows nine points P1 to P9 on projection plane 61 at which illumination intensities are to be measured.

When the relative illumination intensity ratio changes moderately during transition of the light shielding plates from the open position to the closed position, it can be determined that non-uniformity of the illumination intensity caused during transition motion is small. On the other hand, when the relative illumination intensity ratio changes steeply during transition of the light shielding plates, it can be determined that non-uniformity of the illumination intensity caused during transition is large.

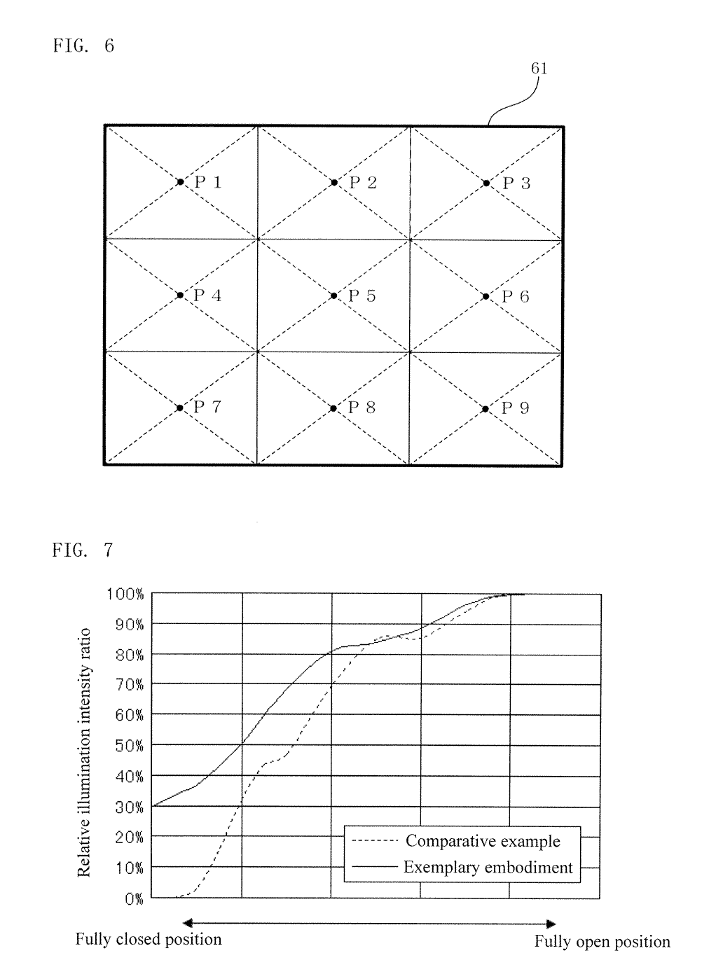

FIG. 7 is a graph showing changes in the relative illumination intensity ratio accompanying opening/closing of the light shielding plates. In the case where light shielding plates 54 and 55 in the comparative example are used, the change in the relative illumination intensity ratio during transition from the fully open position to the fully closed position is steep. In some state in this case, a discrepancy occurs between the change in the open/closed state of the light shielding plates and the change in the relative illumination intensity ratio. On the other hand, in the present exemplary embodiment, the change in the relative illumination intensity ratio is moderate. Further, the relative illumination intensity ratio at the fully closed position is maintained at about 30% of the relative illumination intensity ratio at the fully open position. This is because at the fully open position hexagonal window 41 is formed at the center of two light shielding plates 24 and 25. From this, it can be understood that the illumination intensity at the time of white display is maintained, and non-uniformity of the illumination intensity accompanying opening/closing of the light shielding plates is suppressed in comparison with the case of the light shielding plates in the comparative example.

The in-plane illumination intensity ratio defined below is next evaluated. White is displayed by the projection-type display apparatus and the first sum of illumination intensities at the upper left point and the lower right point (point P1 and point P9 in FIG. 7) in the nine points and a second sum of illumination intensities at the upper right point and the lower left point (point P3 and point P7 in FIG. 7) are measured based on the ANSI standard. The in-plane illumination intensity ratio is defined as a value obtained by dividing the difference between the first sum and the second sum by the illumination intensity at the central point in projection plane 61 (point P5 in FIG. 7).

The in-plane illumination intensity ratio is used as an index indicating the non-uniformity of the illumination intensity in projection plane 61. The larger the absolute value of the in-plane illumination intensity ratio, the larger the non-uniformity of illumination in projection plane 61.

When the value of the in-plane illumination intensity ratio is positive, the brightness (illumination intensity) increases along a direction from upper left toward lower right on projection plane 61. When the value of the in-plane illumination intensity ratio is negative, the brightness (illumination intensity) becomes higher along a direction from lower left toward upper right on projection plane 61.

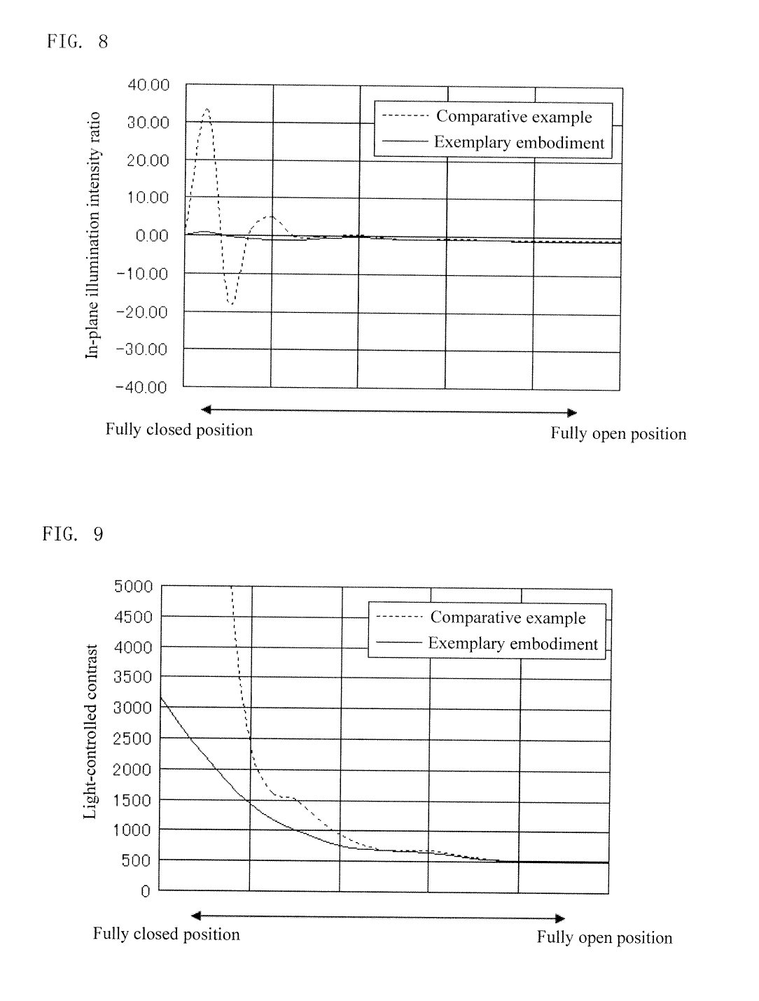

FIG. 8 is a graph showing changes in the in-plane illumination intensity ratio accompanying opening/closing of the light shielding plates. It can be understood that with the light shielding plates in the comparative example, when the light shielding plates are close to the fully closed position, the in-plane illumination intensity ratio changes largely and non-uniformity of the illumination intensity also changes largely.

On the other hand, with light shielding plates 24 and 25 in the present exemplary embodiment, the change in the in-plane illumination intensity ratio is small even when the light shielding plates are close to the fully closed position. That is, it can be understood that the change in non-uniformity of the illumination intensity is largely reduced.

Light-controlled contrast defined below is next evaluated. Light-controlled contrast is defined as the ratio of average illumination intensity at the time of white display and average illumination intensity at the time of black display. The average illumination intensity is defined as the average value of the illumination intensities at the nine points in projection plane 61 based on the ANSI standard.

FIG. 9 is a graph showing changes in light-controlled contrast with opening/closing of the light shielding plates. It can be understood that with the light shielding plates in the present exemplary embodiment, light-controlled contrast changes moderately in comparison with the light shielding plates in the comparative example. Also, with the light shielding plates in the present exemplary embodiment, the light-controlled contrast at the fully closed position is about six times higher than the light-controlled contrast at the fully open position, thus achieving high contrast, such as without any problem in use.

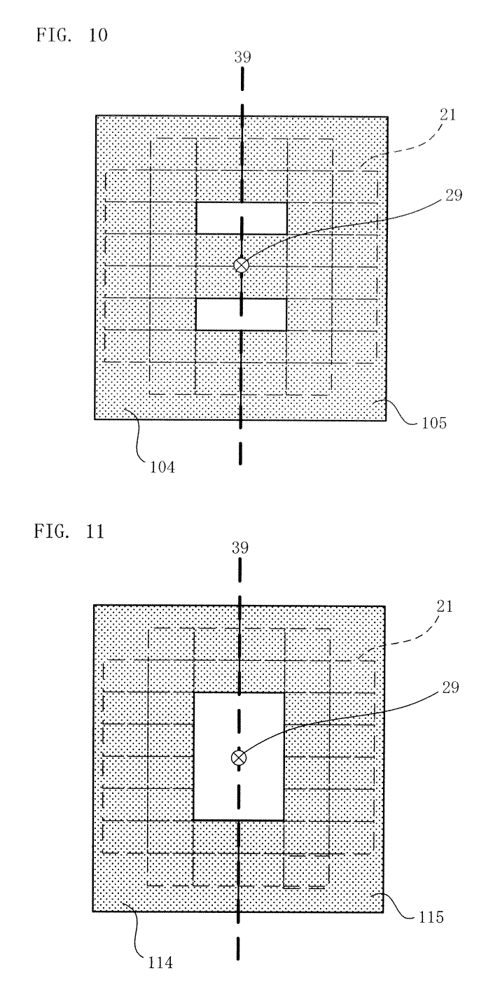

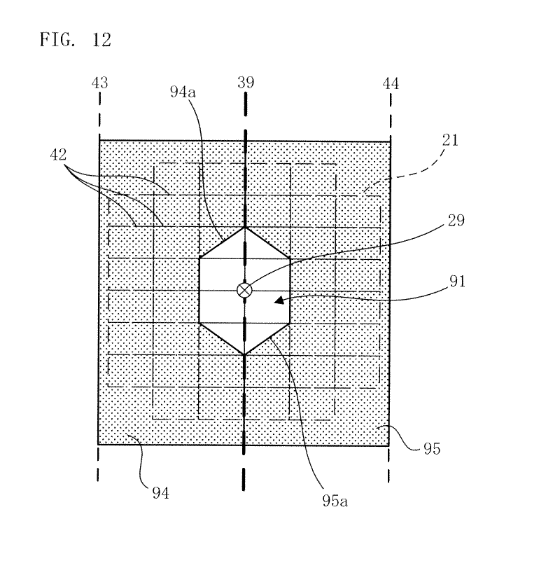

Comparisons have been made between the exemplary embodiment and the light shielding plates as shown in FIG. 5. Light shielding plates 24 and 25 in the present exemplary embodiment also have advantageous effects in comparison with light shielding plates 104 and 105 in a comparative example shown in FIG. 10 or light shielding plates 114 and 115 in a comparative example shown in FIG. 11.

FIG. 12 is a schematic plan view showing a modified example of the first light shielding plate and the second light shielding plate. First light shielding plate 94 and second light shielding plate 95 in the modified example differ only in shape from light shielding plates 24 and 25 shown in FIG. 4.

Cuts 94a and 95a are respectively formed in one-end sides of first light shielding plate 94 and second light shielding plate 95. Cut 95a in the second light shielding plate has a shape such as to form symmetry about optical axis 29 with out 94a in the first light shielding plate. When first light shielding plate 94 and second light shielding plate 95 are in the fully closed position, cut 94a in the first light shielding plate and cut 95a in the second light shielding plate form hexagonal window 91 through which light can pass.

At the fully closed position, at least four central lens elements close to each other in lens arrays 21a and 21b are contained in hexagonal window 91.

Hexagonal window 91 includes two sides extending along boundary lines 42 between the plurality of lens elements parallel to each other and four sides at angles from boundary lines 41 that are located between the plurality of lens elements.

In this modified example, the angles of the four sides of hexagonal window 91 from boundary lines 41 that are located between the plurality of lens elements are different from those shown in FIG. 4. Also in the case of this modified example, the same effects as those of light shielding plates 24 and 25 shown in FIG. 4 are obtained.

While the exemplary embodiment has been presented and described in detail, it is to be understood that various changes and modifications can be made as long as they do not depart from the gist and scope of the appended claims.

### REFERENCE SIGNS LIST

10 Projection-type display apparatus

11 Casing

11a First casing portion

11b Second casing portion

12 Light source

13 Optical engine

14 Projection lens

15 Power supply unit

16 Main circuit board

21 Integrator

21a, 21b Lens array

22 Holder

23 Light control unit

24 First light shielding plate

24a Cut in first light shielding plate

25 Second light shielding plate

25a Cut in second light shielding plate

29 Optical axis of integrator

31 Drive pin

32 Drive member

33 Pin guide

34 Translation guide

35 Rack gear

36 Rotating gear train

39 Reference plane

41 Window

42 Boundary line between lens elements

43, 44 Turn axes

61 Projection plane

1. A projection-type display apparatus comprising:
a light source;
an integrator that uniformizes a distribution of intensity of illumination light from said light source, and that includes a lens array in which a plurality of lens elements are arranged in matrix form; and
a first light shielding plate and a second light shielding plate disposed in said integrator and constructed so as to be able to open and close in cooperation with each other in such a manner as to adjust a quantity of the light,
wherein said first light shielding plate and said second light shielding plate are each constructed so as to be made turnable about a respective turn axis parallel to one direction of an arrangement of the plurality of lens elements;
cuts symmetric with each other are respectively formed in end sides of said first light shielding plate and said second light shielding plate opposed to each other;
the cuts in said first light shielding plate and said second light shielding plate are constructed so as to form, when said first light shielding plate and said second light shielding plate are in a state of limiting the quantity of light to the minimum, a hexagonal window through which light can pass; and
the hexagonal window includes a first region in rectangular form corresponding to at least four central lens elements close to each other in the plurality of lens elements of the lens array, and a second region in triangular form including two sides at angles from boundary lines between the plurality of lens elements.

2. The projection-type display apparatus according to claim 1, wherein when said first light shielding plate and said second light shielding plate are in the state of limiting the quantity of light to the minimum, six vertices of the hexagonal window substantially coincide with points at which the boundary lines between the plurality of lens elements intersect each other.

3. The projection-type display apparatus according to claim 1, wherein when said first light shielding plate and said second light shielding plate are in the state of limiting the quantity of light to the minimum, an optical axis of said integrator passes through a center of the hexagonal window.

4. The projection-type display apparatus according to claim 2, wherein when said first light shielding plate and said second light shielding plate are in the state of limiting the quantity of light to the minimum, an optical axis of said integrator passes through a center of the hexagonal window.
